(19) United States
(12) Patent Application Publication
(10) Pub. No.: US 2006/0084477 A1
(43) Pub. Date: Apr. 20, 2006

(54) Custom navigation menu for a mobile device

(75) Inventors: Yavor Eliad Wardimon, Binyamina (IL); Ram Machness, Tel Aviv (IL)

Correspondence Address: F. JASON FAR-HADIAN;CENTURY IP LAW GROUP, PO BOX 7333, NEWPORT BEACH, CA, 92658-7333, US

(73) Assignee: Mobile (R&D) Ltd.

(21) Appl. No.: 10/968,655

(22) Filed: Oct. 18, 2004

(51) Int. Cl. H04M 1/00

(52) U.S. Cl. 455/566; 455/418

(57) ABSTRACT

A method of customizing a navigation menu of a mobile device is provided. The method comprises selecting a first screen displayed on the mobile device in accordance with a first navigation order; and assigning to the first screen a second navigation order.

### BACKGROUND

### Field of Invention

The present invention relates generally to customizing menu settings and, more particularly, to a system and method for customizing the navigation menu structure for a mobile device.

### COPYRIGHT & TRADEMARK NOTICES

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

### RELATED ART

Mobile devices, particularly cellular phones, are so popular that manufacturers and service providers continuously add additional features and functionality to their products to attract more buyers and subscribers. Each additional function is typically accessible via the mobile device's graphic user interface or menu.

As the number of features increases, the burden is on the user to learn how to navigate through the interface menu to access certain information or to activate a particular feature of the mobile device. Due to the number of menu levels and the respective options provided at each level, sometimes the user may have to navigate through a series of menu screens until an intended target screen is displayed.

When the user frequently accesses a particular screen or menu option to perform a function or activate a feature on a regular basis, browsing through the multiple screens implemented in a hierarchical menu structure can be very inconvenient. For example, a user may have to check a message box on his mobile device several times a day. And thereafter, the user may want to immediately view or access one or more pending transactions in his stock portfolio, for example.

In order to do this, the user will have to browse through several intermediary screens and press several buttons to view the message box screen and then press several other buttons to navigate to the stock portfolio screen. In some instances, the user will then again have to press several other buttons to return to the message box screen.

Understandably, it would be very helpful for the user to bypass the intermediary screens and get to the often-used screens in a more expedited manner. Methods and systems are needed that can accommodate the user accordingly.

### SUMMARY

The present disclosure is directed to a system and corresponding methods that facilitate the process of customizing menu navigation structure for a mobile device.

For purposes of summarizing, certain aspects, advantages, and novel features of the invention have been described herein. It is to be understood that not all such advantages may be achieved in accordance with any one particular embodiment of the invention. Thus, the invention may be embodied or carried out in a manner that achieves or optimizes one advantage or group of advantages as taught herein without achieving other advantages as may be taught or suggested herein.

In one embodiment, a method of customizing a navigation menu for a mobile device comprises selecting a first menu screen displayed on the mobile device in accordance with a first navigation order; and assigning a second navigation order to the first menu screen. The method may further comprise determining if a prohibition is associated with assigning the second navigation order to the first menu screen.

The first menu screen is displayed on the mobile device in accordance with the first navigation order, when a prohibition is associated with assigning the second navigation order to the first menu screen. The first menu screen is displayed on the mobile device in accordance with the second navigation order, when a prohibition is not associated with assigning the second navigation order to the first menu screen. A remote service provider may perform the selecting and assigning steps in one embodiment.

In accordance with another embodiment, a method of customizing a navigation menu structure installed on a mobile device comprises selecting a first navigation menu structure from a plurality of navigation menus available on a remote computing system; and downloading the first navigation menu structure from the remote computing system to the mobile device.

In certain embodiments, the navigation menu structure installed on the mobile device is replaced with the first navigation menu structure. A remote service provider performs the selecting step in accordance with one embodiment. The downloading step may be performed by the service provider in response to a user subscribing to a first feature provided by the service provider.

In accordance with yet another embodiment, a system for customizing a navigation menu for a mobile device is provided. The system comprises circuitry for selecting a first menu screen displayed on the mobile device in accordance with a first navigation order; and circuitry for assigning a second navigation order to the first menu screen.

The system may also comprise circuitry determining if a prohibition is associated with assigning the second navigation order to the first menu screen and circuitry displaying the first menu screen on the mobile device in accordance with the second navigation order. A memory may be also provided for storing at least one of the first and second navigation orders so that a user can select between the first and second navigation orders.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

Embodiments of the present invention are understood by referring to the figures in the attached drawings, as provided below.

FIG. 1 illustrates an exemplary system environment for customizing a navigation menu structure for a mobile device, in accordance with one or more embodiments of the invention;

FIG. 2A is a block diagram of an exemplary navigation menu structure, in accordance with one or more embodiments;

FIG. 2B is a flow diagram of a method of customizing a navigation menu structure for a mobile device, in accordance with one or more embodiments; and

FIGS. 3A and 3B are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION

An electronic system and corresponding methods, according to an embodiment of the present invention, facilitate and provide a method and system for customizing the navigation menu structure for a mobile device.

Electronic services, services, and online services are used interchangeably herein. The services provided by the system of this invention, in one or more embodiments, are provided by a service provider. A service provider is an entity that operates and maintains the computing systems and environment, such as server systems and infrastructures that enable the delivery of information. Typically, server architecture includes components (e.g., hardware, software, and communication lines) that store and offer electronic or online services.

In the following, numerous specific details are set forth to provide a thorough description of various embodiments of the invention. Certain embodiments of the invention, however, may be practiced without these specific details or with some variations in detail. In some instances, features not pertinent to the novelty of the system are described in less detail so as not to obscure other aspects of the invention.

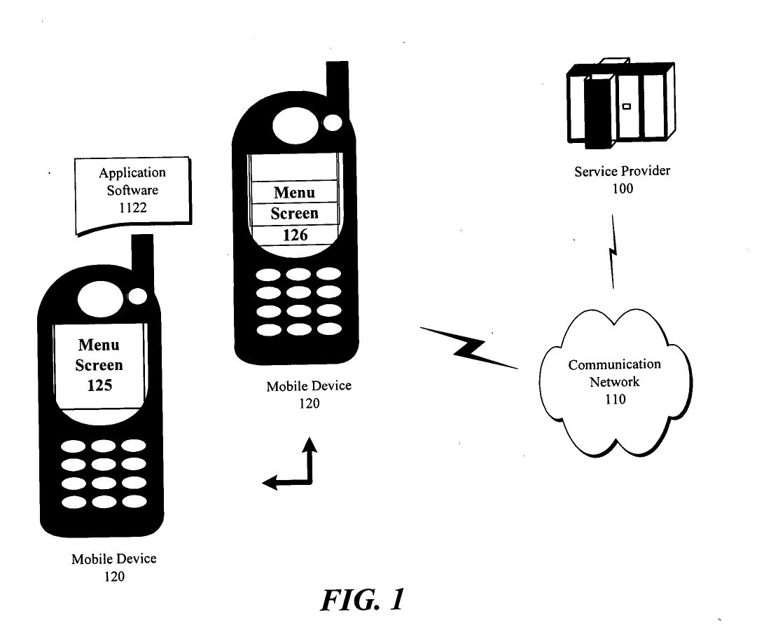

Referring to the drawings, FIG. 1 illustrates an exemplary system environment in which the present invention may operate. In accordance with one aspect of the invention, the system environment comprises a service provider 100, a communication network 110 and a mobile device 120. The service provider 100 and mobile device 120 are connected by way of the communication network 110. The terms “connected,” “coupled,” or any variant thereof, mean any connection or coupling, either direct or indirect, between two or more elements. The coupling or connection between the elements can be physical, logical, or a combination thereof.

In one embodiment, the communication network 110 provides the medium and infrastructure for transmitting digital or analog signals between service provider 100 and mobile device 120. In certain embodiments, mobile device 120 is a cellular telephone and communication network 110 is a wireless telephone network, for example. Mobile device 120, service provider 100 and communication network 110, however, may be implemented over any type of mobile, fixed, wired or wireless communication technology (e.g., landline telephony, cellular, radio, radar, infrared, laser, etc.).

One of ordinary skill in the art will appreciate that communication network 110 may advantageously be comprised of one or a combination of various types of networks without detracting from the scope of the invention. Such networks can, for example, comprise personal area networks (PANs), local area networks (LANs), wide area networks (WANs), public, private or secure networks, value-added networks, interactive television networks, wireless communications networks, two-way cable networks, satellite networks, interactive kiosk networks, cellular networks, personal mobile gateways (PMGs) and/or any other suitable communications networks that can provide a means of communication between mobile device 120 and service provider 100.

In some embodiments, communication network 110 can be a part of the world wide web (i.e., the Internet). The Internet, in a well-known manner, connects millions of computers world wide through standard common addressing systems and communications protocols (e.g., Transmission Control Protocol/Internet Protocol (TCP/IP), HyperText Transport Protocol) creating a vast communications network.

In either context, mobile device 120 can communicate with service provider 100 to send and receive electronic packets of information, in form of electronic requests and responses. In a particular embodiment, the packets are constructed based on a messaging service, such as short messaging service (SMS), instant messenger (IM) service, or multimedia messaging service (MMS). SMS, IM and MMS enable messages comprising text or multimedia content to be communicated to mobile device 120.

In accordance with one aspect of the invention, application software 1122 is installed or executed on at least one of mobile device 120, service provider 100, a third party portal, or a distributed environment comprising a plurality of said systems to allow a user to customize mobile device 120's navigation menu structure. The navigation menu comprises a hierarchical data structure that includes references to several menu screens and defines a navigation path for accessing each screen.

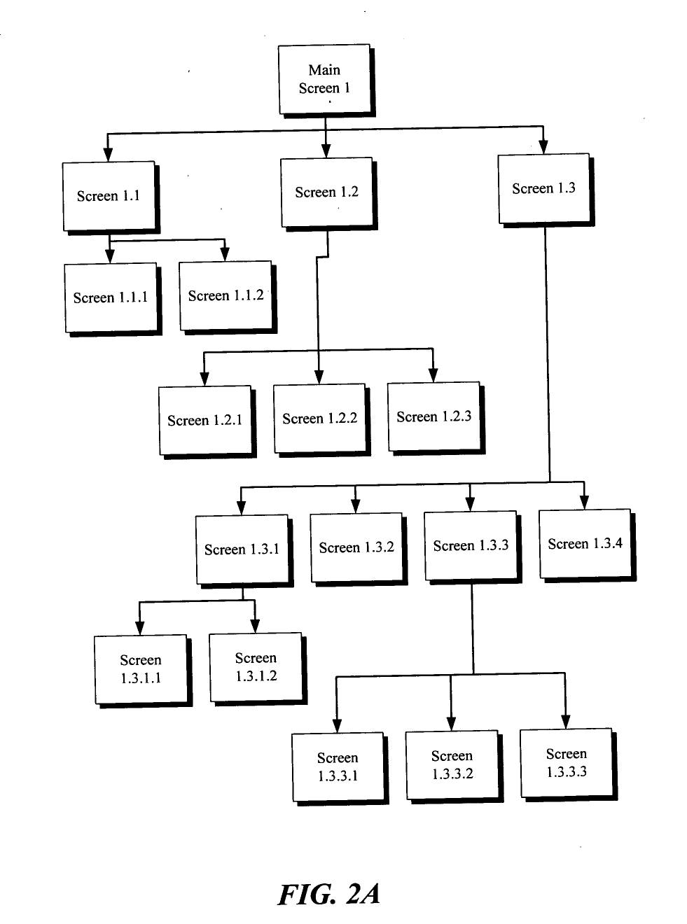

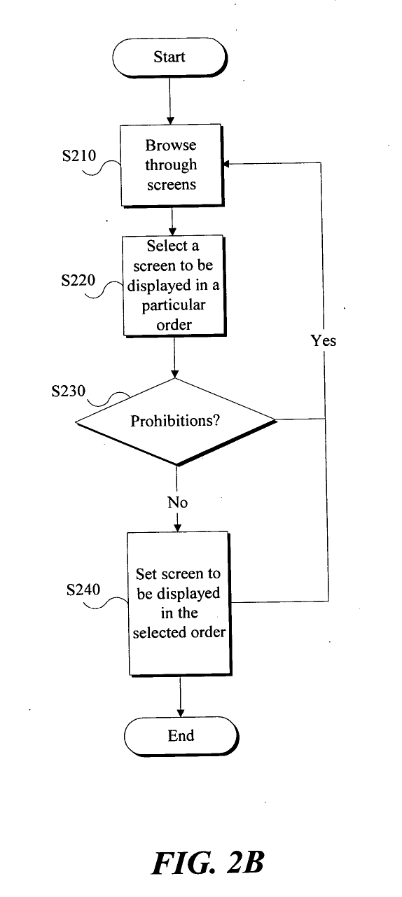

An exemplary navigation menu structure is illustrated in FIG. 2A. In one embodiment, a main screen (i.e., a main menu) is provided at the root of the navigation menu structure, as shown. The main screen and the other menu screens in the navigation menu comprise graphic or text that appears on mobile device 120's display. The menus provide a user with instructions or options for accessing or activating certain features of mobile device 120. As such, once a mobile device 120 is turned on, the user is provided with Main Screen 1, for example, from which a user can access other menu screens by pressing one or more buttons.

As shown in FIG. 2A, in order to access a screen at a lower level of the navigation menu (e.g., Screen 1.3.3.1) a user will navigate through several menu levels and menu screens (e.g., Main Screen 1, Screen 1.3, Screen 1.3.3, screen 1.3.3.1). As such, for the user to access a certain menu screen, a user may press a number of buttons or select a number of graphic user interface icons to navigate through the corresponding menu screens, one at a time.

For example, a user may press a first button to access a first menu screen that provides the user with options to access information stored in mobile device 120. The stored information may be related to, for example, one of the user's event calendar (e.g., Screen 1.1), phone book (e.g., Screen 1.2), SMS messages (e.g., Screen 1.3), etc. If the user wants to view the stored SMS messages, for example, the user then navigates from options available on Main Screen 1, for example, to view the SMS message screen (e.g., Screen 1.3).

The user, thereafter, may press or select another button to view a particular SMS message from among the list of message displayed on the SMS message screen (e.g., Screen 1.3). Each message can be viewed in its respective screen (e.g., Screen 1.3.1, Screen 1.3.2, Screen 1.3.3, or Screen 1.3.4). Thus, when the user selects to view, for example, the first message from the list, the user is provided with the first screen (e.g., Screen 1.3.1) that contains the first SMS messages.

Once the user is provided with the respective message screen (e.g., Screen 1.3.1) then the user may be given two options, for example, to reply to the displayed message or to view the next message. If the user chooses to reply, then another screen (e.g., Screen 1.3.1.1) is displayed that will allow the user to compose a message. If the user chooses to view the next message, then the corresponding screen (e.g., Screen 1.3.1.2 or Screen 1.3.2) is displayed.

In one embodiment, application software 1122 is implemented to allow a user to customize the order in which particular menu screens are to be displayed. That is, application software 1122 is implemented to allow a user to modify the hierarchical structure of the navigation menu for one or more menu screens. Accordingly, a user will be able to alter the navigation route provided by the manufacturer or a service provider and thus customize his or her menu navigation experience in accordance with his or her preference.

Application software 1122 provides the user with the option of ordering the most frequently accessed or viewed menu screens, for example, to a higher hierarchical level in the navigation menu. As such, the user will be able to more conveniently access or view the respective screens, without pressing multiple buttons and selecting from multiple menu and submenu levels, in order to view a target screen.

Advantageously, a user may switch back to the default or manufacturer provided menu, or alternatively customize the hierarchical order of the navigation menu as the user's navigation preference changes. For example, in one embodiment of the invention, a user may be provided with the option to choose from a plurality of navigation menu options available from service provider 100 (i.e., a remote server system) and download a new menu structure to mobile device 120 over communication network 110.

In an alternative embodiment, application software 1122 provides the user with the option to reassign a screen displayed on mobile device 120 to a higher or lower level of hierarchy in the menu structure in order to customize the navigation route for accessing the particular screen. Thus, referring to FIG. 2B, a user utilizing application software 1122 interacts with mobile device 120's user interface to browse through mobile device 120's menu screens (S210).

For example, a user who often accesses his or her message box for incoming SMS messages may utilize application software 1122 to set Main Screen 1 to be the screen containing the first message pending in the SMS message box (e.g., Screen 1.3.1). From that screen, the user will be able to navigate to other related screens (e.g., Screen 1.3.1, Screen 1.3.1.2, Screen 1.3.1, etc.) to reply to or to view the next SMS message, for example, without having to navigate all the way down from the Main Screen to the submenu levels that provide access to the SMS message box.

Thus, in accordance with one aspect of the invention, application software 1122 allows the user to select one or more screens to be displayed in a particular order (S220). In the above example, the user may utilize application software 1122 to reorder the navigation menu structure such that the Main Screen 1 displays the first message pending in the SMS message box (e.g., initially Screen 1.3.1).

A special key or a button may be implemented on mobile device 120 to provide the user with the option to change the hierarchical position of each screen in the menu structure. This may be configured by, for example, assigning a relative number to each menu screen, wherein said number indicates the particular order of the screen in the navigation menu structure. In other embodiments, different methods for configuring the navigation order may be implemented. For example, a graphic interface may be implemented to allow a user to move a screen to a higher or lower position in the hierarchical menu structure.

Once the navigation order of the selected screen is assigned, application software 1122 determines if there is a prohibition against the assignment (S230). For example, application software 1122 may be implement to prevent an assignment that results in an infinite recursive loop in the navigation structure from which the system cannot recover. Other possible prohibitions may be also implemented, for example, to reduce the complexity of the navigation menu structure by limiting the number of nested submenus in the menu structure.

If there are no prohibitions, application software 1122 configures the navigation menu's respective screens to be displayed (i.e., navigated) in the selected order (S240). As a result, the next time a user navigates through the menu structure, the modified navigation route is provided to the user. In one embodiment, application software 1122 allows a user to maintain the original navigation menu structure and store the modified navigation menu structure as an alternative menu.

That is, the user will have the option to create multiple navigation menu structures that can be used in different circumstances. For example, a user may create a first navigation menu for use while at work, a second navigation menu for use while at home, and a third navigation menu for use while on vacation, by interfacing with application software 1122 installed or executed on mobile device 120.

In other embodiments, application software 1122 may be stored or executed on a service provider 100 or a third party portal connected to mobile device 120. Application software 1122, for example, may allow a user to download one or more navigation menu structures to mobile device 120 over communication network 110. Thus, instead of creating or modifying an existing navigation menu, a user may select from a list of available navigation menus.

In one embodiment, a new navigation menu structure may be downloaded from service provider 100 or a third party portal when the user subscribes to a new service that is not supported by the previous navigation menu structure installed on mobile device 120. The download may be initiated by service provider 100 or the third party portal, either automatically at the time of subscription, or by mobile device 120 at a later time.

As used herein, the terms mobile device, third party portal, service provider and communication network are to be viewed as designations of one or more computing environments that comprise application, client or server software for servicing requests submitted by respective software included in devices or other computing systems connected there to. These terms are not to be otherwise limiting in any manner. Application software 1122, for example, may be comprised of one or more modules that execute on one or more computing systems, provided above.

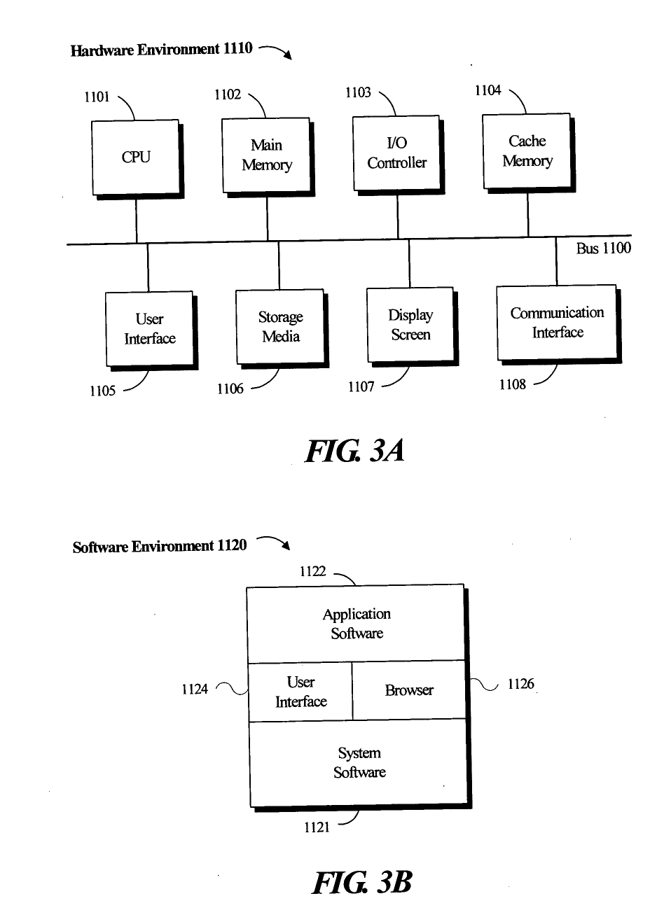

In one or more embodiments of the system, service provider 100, communication network 110, and mobile device 120 comprise a controlled computing system environment that can be presented largely in terms of hardware components and software code executed to perform processes that achieve the results contemplated by the system of the present invention. A more detailed description of such system environment is provided below with reference to FIGS. 3A and 3B.

As shown, a computing system environment is composed of two environments, a hardware environment 1110 and a software environment 1120. The hardware environment 1110 comprises the machinery and equipment that provide an execution environment for the software. The software provides the execution instructions for the hardware. It should be noted that certain hardware and software components may be interchangeably implemented in either form, in accordance with different embodiments.

Software environment 1120 is divided into two major classes comprising system software 1121 and application software 1122. System software 1121 comprises control programs, such as the operating system (OS) and information management systems that instruct the hardware how to function and process information. Application software 1122 is a program that performs a specific task. In some embodiments of the invention, system and application software are implemented and executed on one or more hardware environments to allow a user customize mobile device 120's navigation menu.

Referring to FIG. 3A, an embodiment of application software 1122 can be implemented as computer software in the form of computer readable code executed on a general purpose hardware environment 1110 that comprises a central processor unit (CPU) 1101, a main memory 1102, an input/output controller 1103, optional cache memory 1104, a user interface 1105 (e.g., keypad, pointing device, etc.), storage media 1106 (e.g., hard drive, memory, etc.), a display screen 1107, a communication interface 1108 (e.g., a network card, a modem, or a wireless communication chipset) and a system synchronizer (e.g., a clock).

Processor 1101 may or may not include cache memory 1104 utilized for storing frequently accessed information. A communication mechanism, such as a bi-directional data bus 1100, can be utilized to provide for means of communication between system components. Hardware Environment 1110 is capable of communicating with local or remotes systems connected to a communications network (e.g., a PAN or a WAN) through communication interface 1108.

In one or more embodiments, hardware environment 1110 may not include all the above components, or may include additional components for additional functionality or utility. For example, hardware environment 1110 can be a laptop computer or other portable computing device that can send messages and receive data through communication interface 1108. Hardware environment 1110 may also be embodied in an embedded system such as a set-top box, a personal data assistant (PDA), a wireless communication unit (e.g., cellular phone), or other similar hardware platforms that have information processing and/or data storage and communication capabilities. For example, in one embodiment of the system, mobile device 120 may be a PMG phone or equivalent.

In certain embodiments of the system, communication interface 1108 can send and receive electrical, electromagnetic, or optical signals that carry digital data streams representing various types of information including program code. If communication is established via the Internet, hardware environment 1110 may transmit program code through an Internet connection. The program code can be executed by central processor unit 1101 or stored in storage media 1106 or other non-volatile storage for later execution.

Program code may be transmitted via a carrier wave or may be embodied in any other form of computer program product. A computer program product comprises a medium configured to store or transport computer readable code or a medium in which computer readable code may be embedded. Some examples of computer program products are CD-ROM disks, ROM cards, floppy disks, magnetic tapes, computer hard drives, and network server systems.

In one or more embodiments of the invention, processor 1101 is a microprocessor manufactured by Motorola, Qualcomm, Texas Instruments, Intel, or Sun Microsystems Corporations. The named processors are for the purpose of example only. Any other suitable microprocessor, microcontroller, or microcomputer may be utilized.

Referring to FIG. 3B, software environment 1120 is stored in storage media 1106 and is loaded into memory 1102 prior to execution. Software environment 1120 comprises system software 1121 and application software 1122. Depending on system implementation, certain aspects of software environment 1120 can be loaded on one or more hardware environments 1110.

System software 1121 comprises control software such as an operating system that controls the low-level operations of hardware environment 1110. Low-level operations comprise the management of the system's resources such as memory allocation, file swapping, and other core computing tasks. In one or more embodiments of the invention, the operating system comprises at least one of Symbian, Nucleus, Microsoft Windows, Palm, or Macintosh operating systems. However, any other suitable operating system may be utilized.

Application software 1122 can comprise one or more computer programs that are executed on top of system software 1121 after being loaded from storage media 1106 into memory 1102. In a client-server architecture, application software 1122 may comprise client software and server software. Referring to FIG. 1, for example, in one embodiment of the invention, client software is executed on mobile device 120 and server software is executed on service provider 100.

Software environment 1120 may also comprise web browser software 1126 for communicating with the Internet. Further, software environment 1120 may comprise a user interface 1124 (e.g., a Graphical User Interface (GUI)) for receiving user commands and data. The commands and data received are processed by the software applications that run on the hardware environment 1110. The hardware and software architectures and environments described above are for purposes of example. Embodiments of the invention may be implemented in any type of system architecture or processing environment.

Embodiments of the invention are described by way of example as applicable to systems and corresponding methods that facilitate recognizing and displaying messages received by a mobile device 120 in accordance with predefined categories. In this exemplary embodiment, logic code for performing these methods is implemented in the form of, for example, application software 1122. The logic code, in one embodiment, may be comprised of one or more modules that execute on one or more processors in a distributed or non-distributed communication model.

It should also be understood that the programs, modules, processes, methods, and the like, described herein are but an exemplary implementation and are not related, or limited, to any particular computer, apparatus, or computer programming language. Rather, various types of general-purpose computing machines or devices may be used with logic code implemented in accordance with the teachings provided, herein. Further, the order in which the steps of the present method are performed is purely illustrative in nature. In fact, the steps can be performed in any order or in parallel, unless indicated otherwise in the present disclosure.

The method of the present invention may be performed in either hardware, software, or any combination thereof. In particular, the present method may be carried out by software, firmware, or macrocode operating on a computer or computers of any type. Additionally, software embodying the present invention may comprise computer instructions and be stored in a recording medium (e.g., memory stick, ROM, RAM, magnetic media, punched tape or card, compact disk (CD), DVD, etc.). Furthermore, such software may be transmitted in the form of a computer signal embodied in a carrier wave, and through communication networks by way of Internet portals or websites, for example. Accordingly, the present invention is not limited to any particular platform, unless specifically stated otherwise in the present disclosure.

The present invention has been described above with reference to preferred embodiments. However, those skilled in the art will recognize that changes and modifications may be made in these preferred embodiments without departing from the scope of the present invention.

The embodiments described above are to be considered in all aspects as illustrative only and not restrictive in any manner. Thus, other system architectures, platforms, and implementations that can support various aspects of the invention may be utilized without departing from the essential characteristics as described herein. These and various other adaptations and combinations of features of the embodiments disclosed are within the scope of the invention. The invention is defined by the claims and their full scope of equivalents.

1. A method of customizing a navigation menu for a mobile device, the method comprising:
selecting a first menu screen displayed on the mobile device in accordance with a first navigation order; and
assigning a second navigation order to the first menu screen.

2. The method of claim 1 further comprising:
determining if a prohibition is associated with assigning the second navigation order to the first menu screen.

3. The method of claim 1 further comprising:
displaying the first menu screen on the mobile device in accordance with the second navigation order.

4. The method of claim 2, further comprising:
displaying the first menu screen on the mobile device in accordance with the first navigation order, when a prohibition is associated with assigning the second navigation order to the first menu screen.

5. The method of claim 2, further comprising:
displaying the first menu screen on the mobile device in accordance with the second navigation order, when a prohibition is not associated with assigning the second navigation order to the first menu screen.

6. The method of claim 1, wherein a remote service provider performs the selecting and assigning steps.

7. A method of customizing a navigation menu structure installed on a mobile device, the method comprising:
selecting a first navigation menu structure from a plurality of navigation menus available on a remote computing system; and
downloading the first navigation menu structure from the remote computing system to the mobile device.

8. The method of claim 7, further comprising:
replacing the navigation menu structure installed on the mobile device with the first navigation menu structure.

9. The method of claim 7, wherein a remote service provider performs the selecting step.

10. The method of claim 9, wherein the downloading step is performed by the service provider in response to a user subscribing to a first feature provided by the service provider.

11. A system for customizing a navigation menu for a mobile device, the system comprising:
circuitry for selecting a first menu screen displayed on the mobile device in accordance with a first navigation order; and
circuitry for assigning a second navigation order to the first menu screen.

12. The system of claim 11 further comprising:
circuitry for determining if a prohibition is associated with assigning the second navigation order to the first menu screen.

13. The system of claim 111 further comprising:
circuitry for displaying the first menu screen on the mobile device in accordance with the second navigation order.

14. The system of claim 11 further comprising memory for storing at least one of the first and second navigation orders.

15. The system of claim 14, wherein a user can select the at least one of the first and second navigation orders.
